(19) United States
(12) Patent Application Publication
(10) Pub. No.: US 2025/0010798 A1
(43) Pub. Date: Jan. 9, 2025

(54) DRIVER ASSISTANCE SYSTEM FOR A UTILITY VEHICLE WITH A TRAILER, AND METHOD FOR CONTROLLING A SYSTEM OF THIS KIND

(71) Applicant: ZF CV SYSTEMS GLOBAL GMBH, Bern (CH)

(72) Inventors: Andreas GOERS, Pattensen (DE); Tobias KLINGER, Springe (DE); Olaf MENTZENDORFF, Gehrden (DE)

(21) Appl. No.: 18/711,941

(22) PCT Filed: Nov. 9, 2022
(86) PCT No.: PCT/EP2022/081186

§ 371 Date: May 21, 2024

(30) Foreign Application Priority Data
Nov. 25, 2021 (DE) 10 2021 130 882.8

(51) Int. Cl. B60R 1/26; B60R 1/29; B60T 7/22; G06T 7/246; G06T 7/60; G06T 7/73; G06T 11/00; G06V 10/764; G06V 20/20; G06V 20/58; G08G 1/16

(52) U.S. Cl. CPC B60R 1/26; B60T 7/22; G06T 7/248; G06T 7/60; G06T 7/74; G06T 11/001; G06V 10/764; G06V 20/20; G08G 1/164; B60R 1/29; G06T 2200/24; G06T 2207/30252; G06T 2210/08; G06V 20/58

(57) ABSTRACT

The invention relates to a driver assistance system (16) for a utility vehicle (2) with a trailer (8), which system can be used to observe and/or monitor a space (14, 36) behind a driver's cab (6) and has the following: —at least one optical or acoustic sensor (18, 20, 22) which is arranged behind the driver's cab, —wherein, by means of this sensor, images and image sequences within a field of view of the sensor can be captured, —an image processing unit (24) which is electrically connected to the optical or acoustic sensor, —wherein, in the image processing unit, image processing software for image data analysis and image compression is stored, and wherein the image processing unit, by means of the captured images or image sequences, can detect objects and analyse their size, position and movement in relation to a vehicle-fixed coordinate system and can generate compressed object information therefrom, a first wired or wireless data connection (26), —an electronic control unit (28) which has a data input side and a data output side and is separate from the image processing unit, —wherein the electronic control unit is connected or can be connected on the data input side via the first data connection to the image processing unit in order to transfer the object information generated by the image processing unit, —a second wireless data connection (30), and—an electronic terminal (32) having a user interface (34) which is positioned outside the trailer, as well as other features.

### CROSS REFERENCE TO RELATED APPLICATIONS

This application is a U.S. National Phase application under 35 U.S.C. § 371 of International Application No. PCT/EP2022/081186, filed on Nov. 9, 2022, and claims benefit to German Patent Application No. DE 10 2021 130 882.8, filed on Nov. 25, 2021. The International Application was published in German on Jun. 1, 2023 as WO 2023/094144 A1 under PCT Article 21 (2).

### FIELD

The present invention relates to a driver assistance system for a utility vehicle with a trailer, which system can be used to observe and/or monitor a space behind a driver's cab of the utility vehicle. In addition, the invention relates to a method for controlling such a system.

### BACKGROUND

Camera-based reversing assistance systems as well as camera-based load compartment monitoring systems for utility vehicles are known in various designs. However, such driver assistance systems are usually only integrated into trailers of firmly connected towing vehicle-trailer combinations. In vehicle combinations with changing trailers, such as tractors with semi-trailers, the trailer often lacks important prerequisites for equipping or retrofitting the trailer with such a system. Often, there is no standardized data connection between the towing vehicle and the towed vehicle. Or an existing data connection is not suitable for transferring large amounts of data, such as those generated when acquiring images and image sequences in the rear area of the trailer when maneuvering. There are often disturbances in the transfer of camera images to a monitor in the dashboard in the driver's cab of the towing vehicle, or there is no appropriately designed monitor in the driver's cab. The installation of an additional trailer data cable and/or a permanently installed monitor in the driver's cab is time-consuming and expensive. On the other hand, especially when reversing with trailers, damage often occurs due to collisions with obstacles. In practice, there is often no assistant available to instruct the driver, so the risk of maneuvering damage is particularly high. As a result, a suitable driver assistance system is often lacking in practice.

The “TailGUARD” system described in the publication no. 815 020 211.3 (March 2020) “TailGUARD™ für Truck & Bus Applikationen, Systembeschreibung” [“TailGUARD™ for Truck & Bus Applications, System Description”] of the company WABCO is already known. “TailGUARD” is an optional extension of an electronic trailer braking system (TEBS) described in the publication no. 815 020 093.3 (September 2018) “TEBS E Versionen E0 bis E5.5 Systembeschreibung” [“TEBS E Versions E0 to E5.5 System Description”] of the company WABCO. (TEBS Electronic Braking System for Trailers). “TailGUARD” is a reversing assistance system installed in a trailer vehicle, which uses ultrasonic sensors to detect obstacles in the space behind the trailer in a near field of up to two meters. “TailGUARD” assists the driver in reversing by warning when approaching objects, braking independently if necessary, and autonomously stopping the vehicle at a safe distance from the detected object to avoid collisions with pedestrians, loading docks, barriers, trees, forklifts, cars or other objects behind the vehicle. The distance to detected objects can be indicated by a display with LED bars in the driver's cab dashboard and/or by flashing lane departure lights.

The well-known trailer braking system mentioned above can also be extended with the “OptiLink” system, which is also described in WABCO's publication no. 815 020 093.3 (September 2018). “OptiLink” is an application software (app) for mobile devices which, in conjunction with an electronic control unit (“OptiLink ECU”), allows the control of various functions of the trailer vehicle. The system provides easy access to various functions of the electronic trailer braking system, including the “TailGUARD” system.

However, the “TailGUARD” system is not readily compatible with the latest guidelines in accordance with the “Grundsätze für die Prüfung und Zertifizierung von Rückfahrassistenzsystemen für Nutzfahrzeuge” [“Principles for the Testing and Certification of Reversing Assistance Systems for Utility vehicles”] (GS-VL-40 (April 2019), the testing and certification body in the Deutschen Gesetzlichen Unfallversicherung [German Social Accident Insurance] (DGUV)). In particular, neither the position in relation to the vehicle nor the size of a detected object are displayed.

In addition, systems for monitoring the load compartment of a trailer vehicle are known. DE 10 2018 120 333 A1 reveals a method for monitoring a load compartment in a vehicle using an optical sensor installed in the load compartment as well as a control unit with software for carrying out the method. The control unit has wireless or wired interfaces for the optical sensor and for a graphical user interface of a computer. For example, the optical sensor is a camera. The control unit is a brake control unit of an electronic braking system. The computer is, for example, a mobile phone or a navigation computer with application software and a screen as a graphical user interface. The brake control unit receives an image from the camera at a certain point in time and generates a raster image therefrom, from which the occupancy or a change in the occupancy of the load compartment can be seen according to a grid stored in the brake control unit. The raster image is displayed on the graphical user interface.

### SUMMARY

In an embodiment, the present disclosure provides a driver assistance system for a utility vehicle with a trailer, which can be used to observe and/or monitor a space located behind a driver's cab of the utility vehicle, the system comprising at least one optical or acoustic sensor arranged behind the driver's cab of the utility vehicle. The at least one optical or acoustic sensor is configured to acquire images and image sequences within a field of view of the at least one optical or acoustic sensor. The system further comprises an image processor which is electrically connected to the at least one optical or acoustic sensor. Image processing software for image data analysis and image compression is stored in the image processor. The image processor is configured to detect objects by the acquired images or image sequences and analyze the acquired images or image sequences in terms of their size, position and movement in relation to a vehicle-fixed coordinate system and generate compressed object information from the acquired images or image sequences. The system further comprises a first wired or wireless data connection and an electronic controller which has a data input side and a data output side and is arranged separately from the image processor. For transmitting the object information generated by the image processor, the electronic controller is connected or configured to be connected to the image processor on the data input side via the first data connection. The system further comprises a second wireless data connection and an electronic terminal with an electronic graphical user interface, which is positioned outside the trailer. The terminal is wirelessly connected or configured to be connected to the data output side of the electronic controller via the second data connection. Application software is configured to be installed on the terminal, by which the object information provided by the image processor and transferred to the terminal via the electronic controller is configured to be displayed on the user interface as a graphically reduced, spatial or planar geometric representation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a driver assistance system that can be used as a reversing assistance system and as a load compartment monitoring system for a trailer of a vehicle combination according to an embodiment of the invention in a schematic representation;

FIG. 2 shows a space behind the trailer containing several obstacles according to FIG. 1 in a graphically reduced perspective representation;

FIG. 3 a rear compartment of the trailer divided into several areas of different priority according to FIG. 1 in a schematic representation; and

FIG. 4 shows the vehicle combination as shown in FIG. 1 in a schematic top view with the load arranged in the load compartment of the trailer.

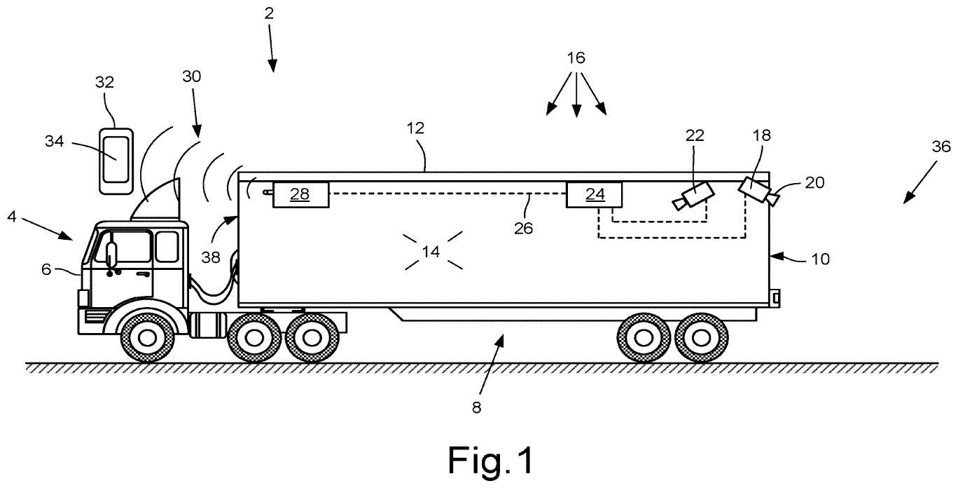

### DETAILED DESCRIPTION

In an embodiment, the present invention provides an improved driver assistance system for a utility vehicle with a trailer, which system is reliable and convenient as well as cost-effective to install or retrofit. A method for controlling such a driver assistance system is also provided.

Accordingly, an embodiment of the invention relates first of all to a driver assistance system for a utility vehicle with a trailer, which system can be used to observe and/or monitor a space behind a driver's cab of the utility vehicle, and which has the following:
at least one optical or acoustic sensor arranged behind the driver's cab of the utility vehicle,
wherein this sensor can be used to acquire images and image sequences within a field of view of the sensor,
an image processing unit that is electrically connected to the optical or acoustic sensor,
wherein image processing software for image data analysis and image compression is stored in the image processing unit,
and wherein the image processing unit can detect objects by means of the acquired images or image sequences and can analyze them with regard to their size, position and movement in relation to a vehicle-fixed coordinate system and can generate compressed object information therefrom,
a first wired or wireless data connection,
an electronic control unit, which has a data input side and a data output side and is arranged separately from the image processing unit,
wherein for transferring the object information generated by the image processing unit the electronic control unit is connected or can be connected to the image processing unit via the first data connection on the data input side,
a second wireless data connection, and
an electronic terminal with an electronic graphical user interface which is positioned outside the trailer,
wherein the terminal is wirelessly connected or can be connected to the data output side of the electronic control unit via the second data connection,
and wherein application software can be installed on the terminal, by means of which the object information provided by the image processing unit and transferred to the terminal via the electronic control unit can be displayed on the user interface as a graphically reduced, spatial or planar geometric representation.

An optical sensor here is a sensor that converts optical information transferred by electromagnetic waves into electrically evaluable signals. The electromagnetic spectrum of an optical sensor includes ultraviolet, visible and infrared light here.

An acoustic sensor is a sensor that converts acoustic information transferred by sound waves into electrically evaluable signals here. The sound wave spectrum of a sound sensor preferably includes ultrasonic waves here, but is not limited to them.

An electronic terminal is a communication device that can be connected wirelessly to a data network or to a radio connection and has a graphical user interface or can be connected to one. Such electronic terminals can be, for example, smartphones, mobile phones, navigation devices, entertainment systems, personal computers, tablets, notebooks, etc. The graphical user interface mentioned above is therefore the display or the screen of the electronic terminal. The electronic terminal can therefore be a mobile device or a device installed in the driver's cab of the towing vehicle.

The term image compression refers to electronic and software-based image processing here, in which a quantity of digital data is reduced in order to shorten the transmission time of the data and reduce the required memory space.

An embodiment of the invention provides an advanced driver assistance system (ADAS; Advanced Driver Assistance System) for a trailer vehicle, which enables a reliable and convenient graphical display on an electronic terminal of obstacles in the rear vicinity of the trailer and/or of the load within a load compartment.

The driver assistance system advantageously combines sensor-based object detection with wireless communication for object data transfer between the trailer vehicle and the electronic terminal or the towing vehicle. The driver assistance system can be easily and cost-effectively installed or retrofitted in a trailer vehicle, as it does not require the establishment of a high-performance wired connection between the towing and towed vehicles. In particular, there is no need for a standardized wired video data connection, which is often absent.

The image data from the sensor is processed in an image processing unit (IPU), which is preferably arranged close to the optical sensor on the trailer vehicle. The image processing unit generates compressed object information, which significantly reduces the amount of image data arising and still contains the essential information about the objects detected by means of the images. This significant reduction in image data in the image processing unit is particularly advantageous, as it enables the transmission of compressed object information via a simple and cost-effective data connection and is still reliable.

Accordingly, one of the main tasks of the image processing unit is to detect objects by sensors and to reduce the transfer bandwidth, i.e. the amount of data to be transferred per second, by limiting it to the essential content. The object detection by sensor should comply with the guidelines already mentioned at the beginning in accordance with the “Grundsätze für die Prüfung und Zertifizierung von Rückfahrassistenzsystemen für Nutzfahrzeuge (Principles for the Testing and Certification of Reversing Assistance Systems for Utility vehicles)” (GS-VL-40, April 2019, Prüf-und Zertifizierungsstelle in der Deutschen Gesetzlichen Unfallversicherung (DGUV) (Testing and Certification Body in the German Social Accident Insurance)). The aim is to achieve the highest possible update rate.

To obtain the object information, the image processing unit reads the images acquired by the sensor and analyzes the detected objects in terms of their position, size, and state of motion in relation to a vehicle-fixed 3D coordinate system. For object detection, the image processing unit can use well-known image processing methods, such as the SfM method (Structure from Motion), which can be used to obtain 3D information by overlapping time-delayed images, or the frame differencing method, which can be used to detect changes in objects in an image sequence.

The compressed object information is transferred to an electronic control unit, which can send data wirelessly on the data output side and receive data wirelessly or wired on the data input side.

The electronic control unit essentially works as a signal amplifier and can be in the form of a separate compact component which is independent of the image processing unit and can be arranged on the trailer vehicle. This means that image processing can be carried out entirely on the trailer vehicle. Thus, in principle, no modifications to the towing vehicle are necessary in order to be able to use the driver assistance system with the features of embodiments of the invention.

The control unit receives the compressed object information, advantageously prepares it into data packets and sends these data packets, for example by means of a communication protocol such as UDP (User Datagram Protocol) that is as uninterruptible as possible via a Wi-Fi radio interface within a wireless local area network (WLAN) or via a Bluetooth connection.

The data packets can be received on a terminal outside or inside the driver's cab of the towing vehicle, for example on a smartphone on which an application software (app) developed or further developed for the driver assistance system is installed. In this application software, the objects detected by sensor are processed in a spatially or planar visible manner as simple geometric figures according to the transferred object information and placed in relation to the trailer vehicle. This results in a user-friendly spatial or planar representation, which can be displayed on a graphical user interface or on a simple display. Due to the reduced amount of data to be transmitted, the display can be updated quickly and continuously at least almost without delay.

It is possible and advantageous to connect the control unit on the data input side to an existing wired bus system of the vehicle, for example to a CAN-5V bus. Such a bus system is usually installed in trailer vehicles that are equipped with an electronic braking system (EBS). There can also already be a control unit in the trailer for signal transfer of various functions for displaying and controlling trailer parameters, such as tire pressure, axle load or level control. Such an existing control unit can be used in addition to transferring the object information to the image processing unit or can be designed with an extension. This is made possible in particular by the fact that the image data are first reduced by the image processing unit, so that the control unit cannot be overloaded.

According to a first embodiment of the driver assistance system, it is designed for use as a reversing assistance system and is used to detect obstacles in a rear space and/or a side space of the trailer when maneuvering the trailer. For this purpose, at least one optical or acoustic sensor is arranged at the rear of the trailer, which senses a rear space and/or a lateral space of the trailer. Compared to existing reversing assistants, the driver assistance system according to embodiments of the invention expands the detection possibilities, in particular by allowing the driver to be shown obstacles three-dimensionally with size and position relative to the vehicle. This makes it easier for the driver to accurately maneuver the trailer rearwards.

Accordingly, an optical or acoustic sensor directed to the rear, i.e. in the reversing direction, can be arranged at the rear end of the trailer vehicle. This sensor can be activated, for example by engaging a reverse gear, to detect obstacles in the trailer's path. It is advantageous if this sensor is designed in such a way that it detects a large horizontal angular range, i.e. a large field of view that extends as far as possible into the lateral area of the trailer.

According to a second embodiment, it provided that the driver assistance system is designed for use as a load compartment monitoring system and is used to monitor a load compartment in the trailer, wherein at least one optical or acoustic sensor is arranged in the load compartment. Accordingly, a sensor can be installed in the load compartment of the trailer, which acquires images or image sequences of the load compartment or load. The acquired images can be converted by means of the image processing unit into a graphically reduced image of the load and displayed. The driver assistance system can therefore have a first sensor for rear space observation and an additional second sensor for load compartment monitoring.

The driver assistance system according to an embodiment of the invention can therefore be operated both as a reversing assistance system and as a load compartment monitoring system. In principle, the load compartment monitoring system and the reversing assistant can both be operated in parallel with the driver assistance system, wherein during reversing the reversing assistant can be expediently prioritized and the load compartment monitoring can be interrupted, at least temporarily.

According to an embodiment of the invention, it can be provided that the electronic control unit is arranged in the front area of the trailer, i.e. close to the driver's cab of the towing vehicle.

It is advantageous to keep the wireless signal distance between the control unit and the electronic terminal as short as possible. This increases the reliability of the transfer of the object information to the terminal. The terminal will be in the driver's field of view when reversing, so that these obstacles that appear on the graphical user interface of the terminal can be immediately visually perceived. As a rule, the terminal will therefore be arranged in the driver's cab of the towing vehicle. Alternatively, if the terminal is a mobile device it can be outside the driver's cab of the towing vehicle when the trailer is maneuvered remotely by the driver.

According to a development of the driver assistance system according to an embodiment of the invention, it can be provided that it has at least one optical or acoustic sensor from the group single image camera, video camera, TOF camera, stereo camera, radar sensor, lidar sensor, ultrasonic sensor. Accordingly, depending on the requirements for the observation and/or monitoring function, sensors with different physical measurement principles can be used in the driver assistance system.

In a first version of a sensor, for example, a wide-angle camera with a fisheye lens can be used for the reversing assistance system. This allows objects in the rear vicinity of the trailer to be detected at a horizontal angle of more than 180°.

As an alternative version of the sensor, a stereo camera can be provided. A stereo camera has two synchronized lenses that simultaneously acquire two half-frames from which a 3D image results. As a result, a more precise position detection of detected objects relative to the vehicle can be achieved. In addition, the blind spot along the line of movement of a reversed trailer is eliminated, for which the aforementioned SfM method is suitable.

Another alternative version of a sensor can be a TOF camera. A TOF camera is a 3D camera that uses a time-of-flight method (TOF Time Of Flight). The travel time of a light pulse, which takes the light from the camera to an object and back again, is measured. With a single shot, the distance of each pixel of a lit scene can be precisely determined.

Another alternative version of a sensor can be a radar sensor. A radar sensor emits a bundled electromagnetic wave as a radar signal and evaluates an echo reflected from an object in order to locate the object in question by distance and angle and, if appropriate, to identify it.

As an additional alternative version of a sensor, a lidar sensor (lidar; Light Detection And Ranging) can be provided. Such sensors work on a similar principle to radar sensors, but with laser beams. These sensors are already being used on vehicles in the field of automated and/or driverless driving.

Another alternative version of a sensor can be an ultrasonic sensor. The aforementioned “TailGUARD” system from ZF (formerly WABCO) uses several of these sensors for obstacle detection.

According to an embodiment, it can be provided that an artificial light source is also arranged that can illuminate the field of view of the optical sensor during the acquisition of an image or sequence of images. By artificially illuminating the field of view of the sensor, a consistently high quality of the images can be achieved regardless of the fluctuations in natural brightness.

In order to solve the procedural problem, a method for controlling a driver assistance system for a trailer of a utility vehicle is provided, wherein the driver assistance system has the characteristics of devices according to the present disclosure.

The method is characterized in that:
when the driver assistance system is activated, images and/or image sequences of the space observed or monitored by the sensor are acquired by at least one optical or acoustic sensor,
by means of these images, objects that are arranged in the observed or monitored space are detected by means of the image processing unit and analyzed with regard to the size and position thereof and, optionally, with regard to the state of motion in relation to a vehicle-fixed coordinate system,
compressed object information is generated from the analysis result, which includes the size, position and optionally the state of motion of each object considered by the image processing unit,
this object information is transferred to the terminal via the electronic control unit, and
the object information transferred to the terminal is displayed by means of the application software as a graphically reduced, spatial or planar representation on the graphical user interface,
wherein this representation contains the detected objects as spatial geometric figures or as planar geometric figures, as well as the size, position and state of motion thereof.

With the method according to an embodiment of the invention, the images or image sequences acquired by the sensor with the objects detected therein are first analyzed in the image processing unit and transferred to the control unit as compressed object information by wire, for example via an existing bus system of a trailer braking system, or wirelessly via a radio connection. The control unit acts as a signal amplifier that sends the object information to the terminal as a processed and amplified signal via a radio connection, for example via WLAN or Bluetooth.

The detected objects are made visible as spatial geometric figures, for example as cuboids, cylinders, pyramids, spheres or beams in a spatial representation on the graphical user interface of the terminal. The spatial representation refers to a fixed coordinate system of the trailer vehicle. For example, the size of the cuboids depicted in terms of width, height and depth, as well as the position thereof relative to the trailer, correspond to the dimensions or positions of the objects in question.

Alternatively, an even more data-reduced representation is possible, in which the cuboids or geometric figures are assigned a predefined uniform size. This representation can serve as an initial orientation for the driver as to where obstacles are arranged in the space behind the trailer. The advantage of this is the comparatively small amount of data to be transmitted, so that a less powerful data connection is sufficient. In particular, if an existing digital bus system is used for data transmission between the image processing unit and the control unit, this bus system is only subjected to relatively low loads.

In addition, it is possible to reduce the mentioned 3D representation to a 2D representation. Instead of spatial figures, simple planar geometric figures, such as rectangles, triangles, circles, distance bars or similar figures, can be displayed on the user interface.

The driver assistance system can be activated automatically, sensor-controlled, event-controlled or manually.

In addition, it can be provided that the driver assistance system works as a reversing assistance system which, when the trailer is maneuvered, is used to detect obstacles in a space to the rear and/or side of the trailer, wherein the field of view of the optical or acoustic sensor is divided into sub-areas of different priority and wherein a predetermined number of obstacle-relevant objects is taken into account in each sub-area.

It is therefore advantageous to divide the space behind the trailer into areas when maneuvering and to reduce the display to the essential content in the respective areas. This achieves a good clarity of the representation and limits the amount of data to be transferred to a necessary level. For example, a high-priority area can be set centrally behind the trailer, in which the greatest number of objects classified as relevant is displayed. An area diagonally behind the trailer can be assigned a medium priority with a medium number of objects classified as relevant. A lower priority can be assigned to an area further out with only a few objects classified as relevant.

It is also possible to use the driver assistance system when driving forward. If a sensor is arranged with a lateral field of view, spatial areas can also be assigned different priorities. For example, an area centrally arranged behind the vehicle is given low priority when moving forward, while an area immediately to the side of the vehicle is given high priority. In addition, the lateral areas on the right and left can be weighted differently, depending on the activation of a left or right direction indicator of the vehicle.

According to an embodiment of a method according to the invention, it can be provided that in the event of a possible rearward collision with an obstacle in a predicted path of the utility vehicle, a visual, acoustic and/or haptic collision warning is carried out by means of the application software of the terminal and that automatic emergency braking by means of a trailer braking system is initiated to avoid a collision.

Accordingly, a possible collision can be predicted during reversing if an obstacle appears in the expected path of the trailer. If a collision is classified as indirectly imminent, a warning cascade can first be triggered. Visual feedback can be provided, for example, by the cuboid displayed on the user interface, which represents the object in question, becoming distinctive, for example red and/or flashing.

In addition, or alternatively, a red border can appear at the edges of the interface, or the background can be completely colored a transparent red. The colors of the visual warning, as well as the intensity of the audible or haptic warning, can vary according to the degree of danger. For example, the yellow color can indicate that there are obstacles in the field of view, and the red color can indicate that a collision is imminent. Warning tones can vary in pitch and/or volume depending on the hazard detected. If a collision is considered imminent, it can be avoided or at least mitigated by automatically activating the trailer brakes if an electronic braking system is present.

According to an embodiment of the invention, it can be provided that the geometric figures and/or a frame and/or background of the user interface appearing on the graphical user interface of the terminal can be displayed in different colors and/or in changing colors depending on the size, position and/or state of motion of the objects concerned and depending on a collision warning.

Accordingly, different color schemes can be provided and selectable for the representation of the geometric figures. In the simplest case, all figures can be uniformly colored. For example, the color can change uniformly for all figures depending on the distance of the object closest to the trailer. According to a development of a color scheme, each figure can be color-coded individually and depending on the current outermost point in space thereof as seen from the trailer.

In addition, the state of motion of the detected objects can be analyzed. If a relevant object is detected that performs a proper movement, it can be distinguished from a stationary object by a different coloring and highlighted, for example.

According to an embodiment of the invention, it can be provided that a grid or line pattern is displayed on the graphical user interface of the terminal, which is projected onto a displayed base area.

A grid or line pattern with the geometric figures derived from the objects detected by sensor depicted therein can help the driver understand the depicted scene. For example, when reversing, this can provide the driver with guidance when initiating driving maneuvers. For example, a grid with a predetermined fixed cell size can be projected onto the base area and made visible on the user interface, with each cell corresponding to a 1 m×1 m section of the observed and monitored space. Alternatively, a pattern of lines can be projected onto the base area, wherein the line spacings of the lines shown correspond to certain horizontal equidistant distances in the observed and monitored space with respect to the trailer.

According to an embodiment of the invention, it can be provided that a real background image is displayed on the graphical user interface of the terminal, into which the geometric figures representing the detected objects are projected. If very powerful data connections are available between the image processing unit and the electronic control unit, as well as between the electronic control unit and the terminal, it is also possible to project the geometric figures representing the detected objects into a real background image of the optical sensor.

According to another development of the method, a guard function can be provided which monitors the data transmission and generates a warning message in the event of a detected significant interruption of the data transmission between the image processing unit and the electronic control unit and/or between the electronic control unit and the terminal.

It is well known that with driver assistance systems wireless communication interruptions can repeatedly occur. Therefore, it is advantageous to integrate a diagnostic tool into the driver assistance system according to embodiments of the invention, which detects latency times or gaps in data transmission in order to determine outdated data, or to detect that a displayed image on the user interface does not reflect the current situation. One such diagnostic tool is, for example, the well-known IP ping method, which can be used to check with the help of test signals whether a particular device with an IP address can be reached in a network. If latency is detected, an alert can be generated in the smartphone app, for example represented by an overlay of a yellow or red border along the edges of the display in addition to a warning text such as “no data”.

Appropriately, two ping tests are carried out in order to distinguish between latency times that occur between the image processing unit and the control unit on the one hand and between the control unit and the terminal on the other and, if appropriate, to display a corresponding error code in each case. In the event of frequent problems, the compression rate of the acquired images can be adjusted in the image processing unit, so that a less detailed, but still sufficient display on the user interface results.

According to another development of the method, it is provided that the driver assistance system works as a load compartment monitoring system, wherein load occupancy, load displacement and/or occupancy change is monitor and shown on the graphical user interface of the terminal. The driver assistance system makes it possible to monitor the condition of the load in the load compartment of the trailer. For example, the degree of occupancy or the distribution of the load in the load compartment can be displayed. In addition, by comparing images of the load compartment taken at intervals over time, an undesirable load shift or theft-related load removal can be detected and signaled to the driver.

According to an embodiment of the invention, it can be provided that the driver can set a perspective angle of the display on the graphical user interface of the terminal by means of the application software or can choose and switch between a spatial and a planar representation.

Finally, an embodiment of the invention also relates to a utility vehicle with a trailer which has a driver assistance system for the observation and/or monitoring of a space behind a driver's cab, which is constructed according to a device according to the present disclosure and can be operated to carry out a method according to the present disclosure.

Embodiments of the invention are explained in more detail below using exemplary embodiments shown in the attached drawings.

Some of the components in the figures are identical in their structure and/or function, so that they are designated with the same reference numbers for the sake of simplicity.

The vehicle combination 2 shown here as an example is a semitrailer combination consisting of a towing vehicle 4, in this case a tractor unit with a driver's cab 6, and a trailer 8, in this case a semi-trailer with a box body 12 and a load compartment 14 in it.

The driver assistance system 16 according to an embodiment of the invention is essentially arranged in the trailer 8 and has at least a first optical sensor 18, in the present case a first camera, for rear area monitoring, in addition a second optical sensor 22, in the present case a second camera, for load compartment monitoring, an image processing unit 24, a first data connection 26, an electronic control unit 28, a second data connection 30 and a terminal 32.

The first optical sensor 18 is arranged at the rear 10 of the trailer 8 and has a wide-angle lens 20, such as a so-called fisheye lens, which can be used to acquire images and image sequences of a rear compartment 36 behind the trailer 8. The second optical sensor 22 is arranged inside the load compartment 14. By means of the second sensor 22, images and image sequences of the load compartment 14 can be acquired.

The image processing unit 24 is arranged inside the trailer 8 close to its rear 10 and is electrically connected to the two optical sensors 18, 22. By means of the image processing unit 24, the images acquired by the optical sensors 18, 22 can be analyzed and compressed in such a way that object information is generated in each case, which contains the size, position and state of motion of objects detected with the images in relation to a vehicle-fixed coordinate system.

The electronic control unit 28 is arranged in the area of the front 38 of the trailer 8 and is connected to the image processing unit 24 via the first data connection 26. In the example shown, the first data connection 26 is in the form of a cable connection. For example, this data connection 26 can be part of an existing data bus of an electronic braking system of the trailer 8 and can be used for the connection of the image processing unit 22 and the control unit 28 to transfer the object information. Alternatively, a wireless radio connection is possible. For example, the design of the electronic control unit 28 can be based on the “OptiLink” ECU mentioned at the beginning or can be a further development of this “OptiLink” ECU.

In this example, the terminal 32 is a smartphone with a graphical user interface 34 or display. The terminal 32 communicates wirelessly with the control unit 28 via the second data connection 30, in the present case a WLAN connection. Alternatively, a Bluetooth connection would also be possible. An application software, known as an app for short, is installed in the terminal 32, by means of which the object information generated by the image processing unit 24 and transferred from the control unit 28 to the terminal 32 can be displayed as a graphically reduced, spatial or planar geometric representation.

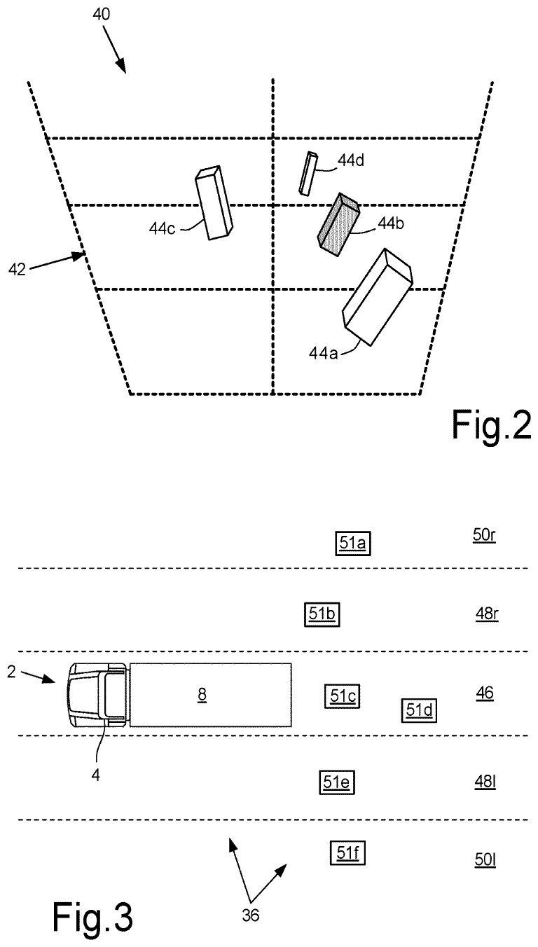

FIG. 2 shows an example of such a spatial representation 40 on the graphical user interface 34 of the terminal 32 when the driver assistance system 16 is used as a reversing assistance system. An image sequence of the rear compartment 36 of the trailer 8 acquired by the first optical sensor 18 while reversing is analyzed by the image processing unit 24. In the present example, four objects were detected, which are relevant as obstacles in the expected travel path of the trailer 8.

The object information transferred to the terminal 32 is converted by the application software of the terminal 32 into the spatial representation 40 shown. In this representation, the four detected real objects are depicted as four cuboid geometric FIGS. 44a, 44b, 44c, 44d. The representation 40 shows the sizes and positions of the geometric FIGS. 44a, 44b, 44c, 44d relative to the trailer 8. Due to the extremely wide field of view of the wide-angle lens 20, the resulting spatial representation 40 appears to be strongly distorted in perspective. For better orientation, the spatial representation 40 is underlaid with a grid 42 by means of the application software. The horizontal grid lines correspond to equidistant distances in the acquired rear space 36.

The second FIG. 44b, hatched in FIG. 2, differs from the other three FIGS. 44a, 44c, 44d in that the object in question is a moving object. This was obtained by the image processing unit 24 by analyzing an image sequence with two or more consecutive images. On the user interface 34, this FIG. 44b appears in a different color, shown here in gray.

FIG. 3 shows the rear compartment 36 of the trailer 8 with a subdivision into a central sub-area 46 and, seen in the forward direction, into a near-vehicle right lateral sub-area 48r, a near-vehicle left lateral sub-area 481, a right lateral sub-area away from the vehicle 50r and a left lateral sub-area away from the vehicle 50r. The software of the image processing unit 24 and/or the application software can have a routine that carries out this subdivision and assigns a priority to the mentioned sub-areas 46, 48r, 481, 50r, 50l. For example, when reversing, a high priority is assigned to the central sub-area 46, a medium priority to the lateral sub-areas close to the vehicle 48r, 481, and a low priority to the lateral sub-areas away from the vehicle 50r, 50l. In addition, the left and right sub-areas 48r, 481, 50r, 50l can be assigned different priorities depending on the driving situation. Based on these priorities, the image processing unit 24 classifies the detected objects 51a, 51b, 51c, 51d, 51e, 51f as relevant and makes a specific selection with a limit on the number of objects in each of the sub-areas 46, 48r, 481, 50r, 50l.

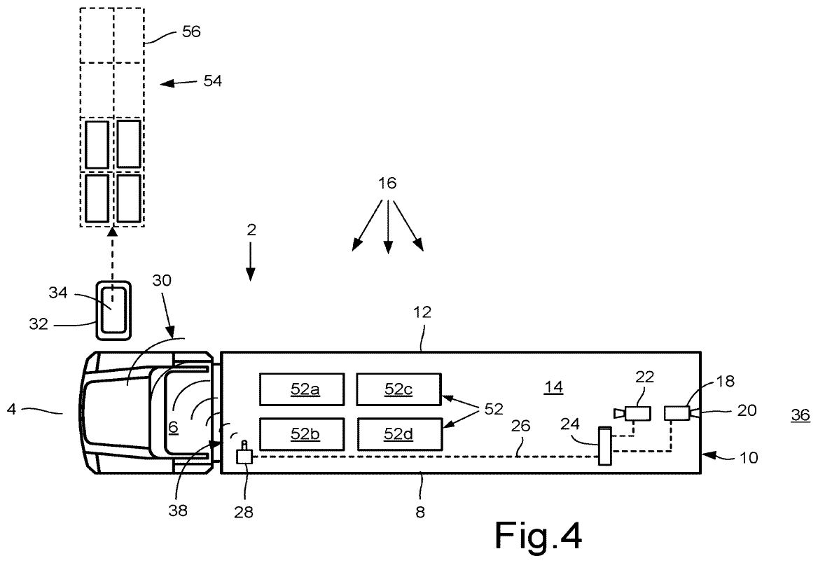

FIG. 4 shows the load compartment 14 of the trailer 8 with a load 52 in it, which in the example shown consists of four load units 52a, 52b, 52c, 52d. Also shown is a graphically reduced representation 54 of the load compartment 14 and the four load units 52a, 52b, 52c, 52d on the graphical user interface 34 of the terminal 32 when the driver assistance system 16 is used as a load compartment monitoring system. For this purpose, the images acquired from the load compartment 14 by the second optical sensor 22 are processed by means of the image processing unit 24 into object information which contains the size and position of the load 52 or the individual load units 52a, 52b, 52c, 52d. The object information is sent to the terminal 32 via the control unit 28. A grid 56 is underlaid on the graphical user interface 34, which makes it relatively easy to derive the degree of occupancy and the load distribution of the load 52 in the load compartment 14. By means of an analysis of image sequences, load shifts or a removal of the load units 52a, 52b, 52c, 52d can also be detected.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGN LIST (PART OF THE DESCRIPTION)

2 Utility vehicle, vehicle combination, semitrailer
4 Towing vehicle, tractor unit
6 Driver's cab
8 Trailer, semi-trailer
10 Rear of the trailer
12 Trailer box body
14 Space behind the driver's cab; load compartment of the trailer
16 Driver assistance system, reversing assistance system, load compartment monitoring system
18 First optical sensor, camera
20 Wide-angle lens of the camera
22 Second optical sensor, camera
24 Image processing unit
26 First data connection, data bus
28 Electronic control unit
30 Second data connection, WLAN, Bluetooth
32 Terminal, smartphone
34 Graphical user interface of the terminal
36 Space behind the driver's cab; rear space behind the trailer
38 Front area of the trailer
40 Representation of the rear space 36 on the user interface
42 Grid of the rear space on the user interface
44a First figurative representation of a first object in the rear space
44b Second figurative representation of a second object in the rear space
44c Third figurative representation of a third object in the rear space
44d Fourth figurative representation of a fourth object in the rear space
46 Central area of the rear space
481 Left side area close to the vehicle
48r Right side area close to the vehicle
50l Left side area away from the vehicle
50r Right side area away from the vehicle
51a-51f Objects in the rear space behind the trailer
52 Load in the load compartment
52a First load unit
52b Second load unit
52c Third load unit
52d Fourth load unit
54 Representation of the load compartment on the user interface
56 Grid of the load compartment on the user interface

1. A driver assistance system for a utility vehicle with a trailer, which can be used to observe and/or monitor a space located behind a driver's cab of the utility vehicle, the system comprising:
at least one optical or acoustic sensor arranged behind the driver's cab of the utility vehicle,
wherein the at least one optical or acoustic sensor is configured to acquire images and image sequences within a field of view of the at least one optical or acoustic sensor;
an image processor which is electrically connected to the at least one optical or acoustic sensor,
wherein image processing software for image data analysis and image compression is stored in the image processor, and
wherein the image processor is configured to detect objects by the acquired images or image sequences and analyze the acquired images or image sequences in terms of their size, position and movement in relation to a vehicle-fixed coordinate system and generate compressed object information from the acquired images or image sequences:
a first wired or wireless data connection;
an electronic controller which has a data input side and a data output side and is arranged separately from the image processor,
wherein for transmitting the object information generated by the image processor, the electronic controller is connected or configured to be connected to the image processor on the data input side via the first data connection;
a second wireless data connection; and
an electronic terminal with an electronic graphical user interface, which is positioned outside the trailer,
wherein the terminal is wirelessly connected or configured to be connected to the data output side of the electronic controller via the second data connection, and
wherein application software is configured to be installed on the terminal, by which the object information provided by the image processor and transferred to the terminal via the electronic controller is configured to be displayed on the user interface as a graphically reduced, spatial or planar geometric representation.

2. The driver assistance system as claimed in claim 1, wherein:
the driver assistance system is configured as a reversing assistance system and, when maneuvering the trailer, is configured to detect obstacles in a rear and/or lateral space of the trailer, and
at the least one optical or acoustic sensor is arranged at a rear of the trailer, which sensorially detects the rear and/or a lateral space of the trailer.

3. The driver assistance system as claimed in claim 1, wherein:
the driver assistance system is configured to be used as a load compartment monitoring system and to monitor a load compartment in the trailer, and
the at least one optical or acoustic sensor is arranged in the load compartment.

4. The driver assistance system as claimed in claim 1, wherein the electronic control unit is arranged in a front area of the trailer.

5. The driver assistance system as claimed in claim 1, wherein the at least one optical or acoustic sensor is selected from the group consisting of a single image camera, video camera, time of flight (TOF) camera, stereo camera, radar sensor, lidar sensor, and ultrasonic sensor.

6. The driver assistance system as claimed in claim 1, further comprising an artificial light source, which illuminates the field of view of the at least one optical sensor during acquisition of the image or sequence of images.

7. A method for controlling the driver assistance system for a trailer of a utility vehicle as claimed in claim 1, wherein:
images and/or image sequences of the space observed or monitored by the at least one optical or acoustic sensor are acquired by the at least one optical or acoustic sensor when the driver assistance system is activated,
by the images and/or image sequences, objects arranged in the observed or monitored space are detected by the image processor and analyzed with regard to their size and position in relation to a vehicle-fixed coordinate system,
compressed object information is generated from the analysis, the compressed object information containing the size, and position of each object taken into account by the image processor,
object information is transferred to the terminal by the electronic controller, and
object information transferred to the terminal is displayed on the graphical user interface by the application software as a graphically reduced, spatial or planar representation, and
the representation contains the detected objects as spatial geometric figures or as planar geometric figures, as well as their size, position and state of motion.

8. The method as claimed in claim 7, wherein the spatial geometrical figures represented are cuboids, cylinders, pyramids, spheres or beams.

9. The method as claimed in claim 7, wherein the planar geometrical figures represented are rectangles, triangles, circles, distance bars.

10. The method as claimed in claim 7, wherein activation of the driver assistance system is automatic, sensor-controlled, event-controlled or manual.

11. The method as claimed in claim 7, wherein:
the driver assistance system is a reversing assistance system, which, when maneuvering the trailer, is configured to detect obstacles in a rear and/or a lateral space of the trailer,
the field of view of the at least one optical or acoustic sensor is divided into sub-areas of different priority, and
in each sub-area, a predetermined number of obstacle-relevant objects are taken into account.

12. The method as claimed in claim 7, wherein:
in the event of a possible rearward collision with an obstacle in a predicted travel path of the utility vehicle, a visual, acoustic and/or haptic collision warning is issued by the application software of the terminal, and
automatic emergency braking is initiated by a trailer braking system in order to avoid a collision.

13. The method as claimed in claim 7, wherein the geometric figures and/or a frame and/or background of the user interface appearing on the graphical user interface of the terminal are displayed in different colors and/or in changing colors depending on the size, position and/or state of movement of the objects concerned and depending on a collision warning.

14. The method as claimed in claim 7, wherein a grid or line pattern is displayed on the graphical user interface of the terminal, which is projected onto a displayed base.

15. The method as claimed in claim 7, wherein a real background image is displayed on the graphical user interface of the terminal, into which the geometrical figures, which represent the detected objects, are projected.

16. The method as claimed in claim 7, wherein a guard function is provided which monitors the data transmission and generates a warning message in the event of a significant interruption of the data transmission between the image processor and the electronic controller and/or between the electronic controller and the terminal.

17. The method as claimed in claim 7, wherein the driver assistance system works as a load compartment monitoring system, wherein load occupancy, load shift and/or occupancy change is monitored and shown on the graphical user interface of the terminal.

18. The method as claimed in claim 7, wherein the driver can set a perspective angle of the display on the graphical user interface of the terminal by the application software or can select and switch between a spatial and a planar display.

19. A utility vehicle with a trailer, comprising the driver assistance system of claim 1.
